(19) United States
(12) Patent Application Publication
(10) Pub. No.: US 2020/0210940 A1
(43) Pub. Date: Jul. 2, 2020

(54) Selecting Project Resources based on Resource Characteristics and Role Correlations

(71) Applicant: International Business Machines Corporation, Armonk, NY (US)

(72) Inventors: Nozomu Matsushita, Tokyo (JP); Kazuro Haga, Tokyo (JP); Katsuroh Hayashi, Fujisawa-shi (JP); Yasuko Andoh, Tokyo (JP)

(21) Appl. No.: 16/238,441

(22) Filed: Jan. 2, 2019

(51) Int. Cl. G06Q 10/06

(52) U.S. Cl. CPC G06Q 10/063118; G06Q 10/06393

(57) ABSTRACT

An approach is provided in which an information handling system computes work role correlation values corresponding to work role pairs that each includes a pair of work roles corresponding to a project. The information handling system groups resources corresponding to the work roles into resource sets, each of which including a unique set of resources. Next, the information handling system computes resource set scores for each of the resource sets based on their respective unique set of resources and the work role correlation values. In turn, the information handling system selects one of the resource sets based on the resource set scores.

### BACKGROUND

A business is only as good as its resources. Owners and managers who understand how to best utilize each resource help shape the success of a business. In addition, properly combining resources into teams to create heightened team chemistry further advances the business’ objectives. Teams with heightened team chemistry understand each other's strengths and weaknesses and work in a manner that maximizes each other's’ strengths and minimizes their weaknesses.

Many factors contribute to team chemistry and successful business owners and hiring managers understand their resources from a complete perspective. Talent and experience are not enough to make a resource a good team member. The resource must also be willing and able to interact with other resources on the team, communicate and listen effectively, and put aside their own personal goals for team goals. A challenge found today is that teams are typically formed by identifying resources based on their skills and availability. Many times, however, the team does not have sufficient chemistry, which leads to inefficient team productivity.

### BRIEF SUMMARY

According to one embodiment of the present disclosure, an approach is provided in which an information handling system computes work role correlation values corresponding to work role pairs that each includes a pair of work roles corresponding to a project. The information handling system groups resources corresponding to the work roles into resource sets, each of which including a unique set of resources. Next, the information handling system computes resource set scores for each of the resource sets based on their respective unique set of resources and the work role correlation values. In turn, the information handling system selects one of the resource sets based on the resource set scores.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting a resource selection system that selects a group of resources based on personal characteristics and work role correlation values;

FIG. 4 is an exemplary flowchart showing steps taken by the resource selection system to select a team for a project;

FIG. 5 is an exemplary diagram depicting steps taken by various system components in team member selection system 300 to select a team based on their team chemistry score;

FIG. 6 is an exemplary diagram depicting a stakeholder entry graph and a correlation graph;

FIG. 7 is an exemplary diagram depicting work role correlation values between two team roles;

FIG. 8 is an exemplary diagram depicting a resource management system identifying possible candidates for a project based on project characteristics;

FIG. 9 is an exemplary diagram depicting a cognitive computing system using historical information to compute a mutual personal chemistry of candidate resources;

FIG. 10 is an exemplary diagram depicting computations of a team chemistry score for one set of resources inserted into a team selection table that includes multiple resource set scores; and

FIG. 11 is an exemplary diagram depicting a history log of information in response to completing a project.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

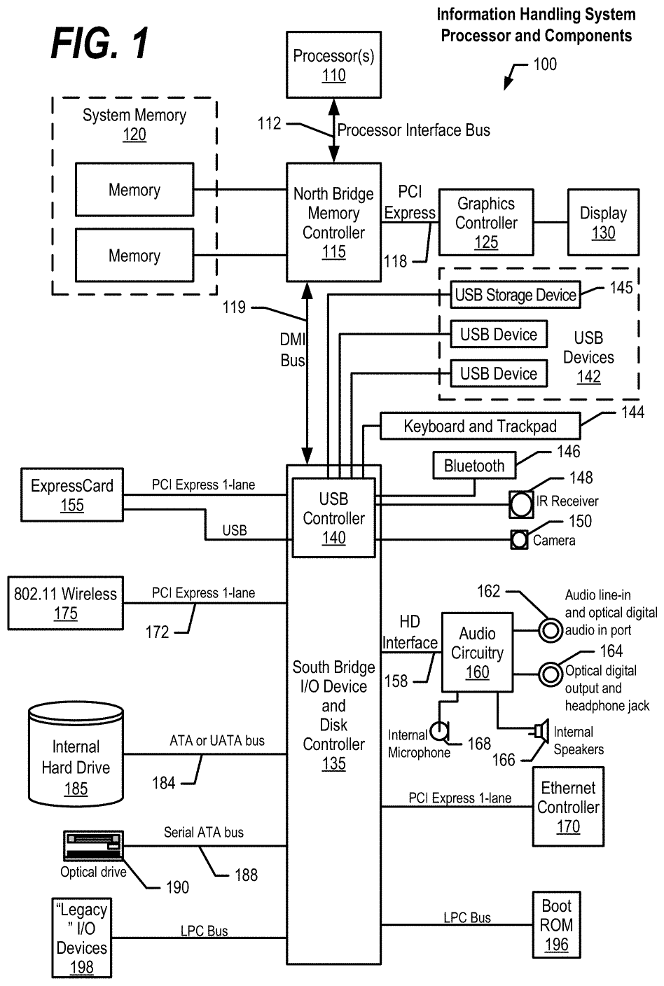

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

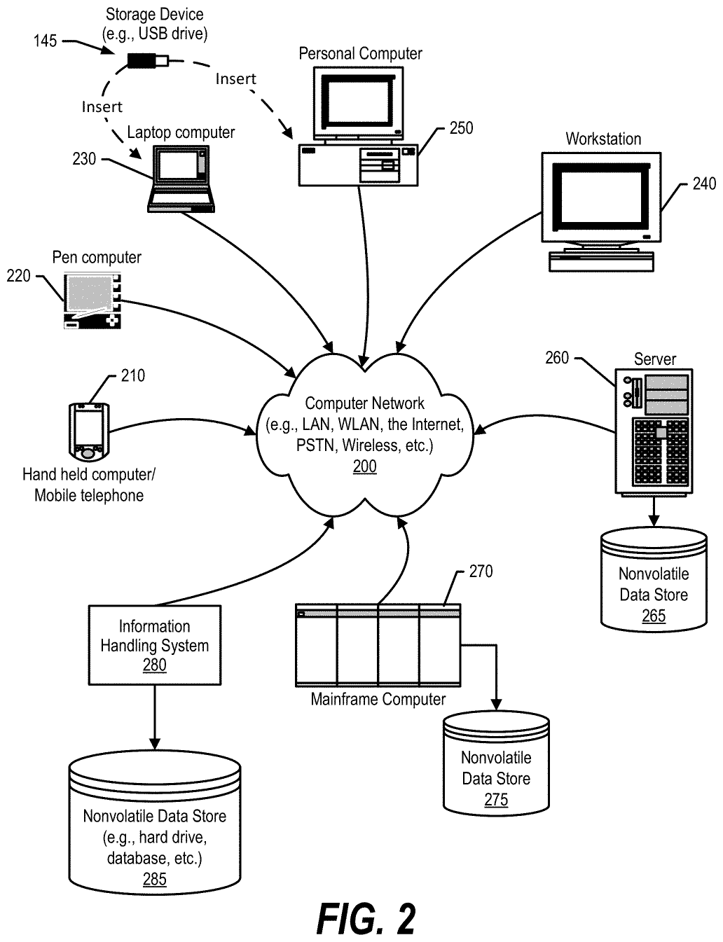

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

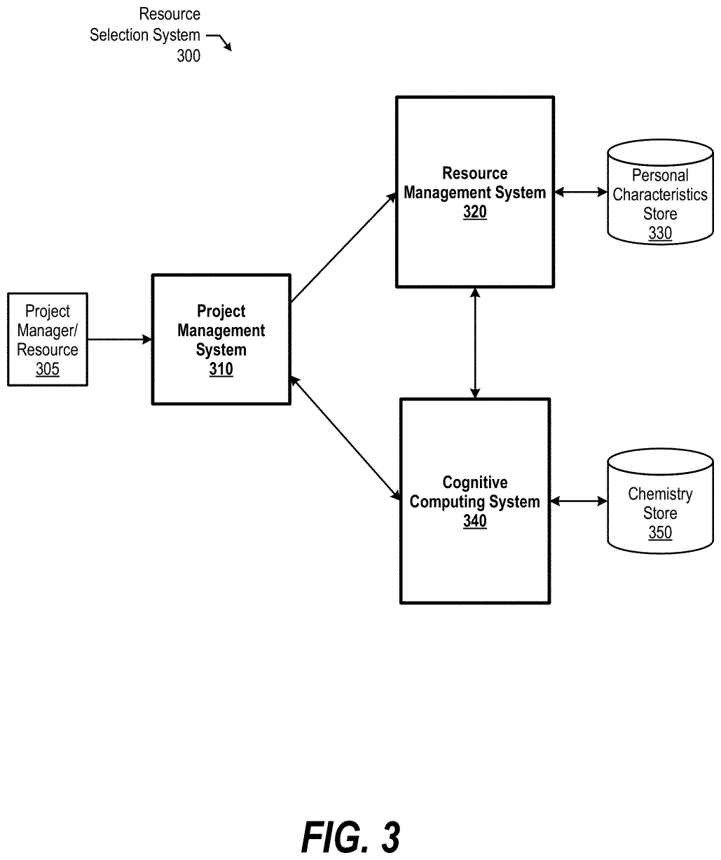

As discussed above, teams (referred to herein as “resource set”) are typically formed by identifying employees (referred to herein as “resource”) based on their skills and availability, which can lead to poor team chemistry and an inefficient team. FIGS. 3 through 10 depict an approach that can be executed on an information handling system that factors in personal characteristics and project work role correlations to compute candidate team scores and assign a highest ranking candidate team to the project. Personal characteristics include personal attributes such as emotional range, openness, conscientiousness, introversion/extroversion, agreeableness, etc. Project work role correlations are based on degrees of separation between a pair of work roles' parameters required for the project.

In one embodiment, selecting project personnel based on personal characteristics increases the probability of success of the organization and/or the project. In another embodiment, when the approach is incorporated into a project management tool, candidate teams can be received from the project information at the start of the project.

In another embodiment, history logs of personal chemistry and project success/failure are accumulated at a company level on a cloud-based system. In this embodiment, the approach utilizes an increased amount of history logs and, in turn, results in an increased accuracy of team member selection success.

FIG. 3 is an exemplary diagram depicting a resource selection system that selects a group of resources based on personal characteristics and work role correlation values, also referred to herein as work role correlations.

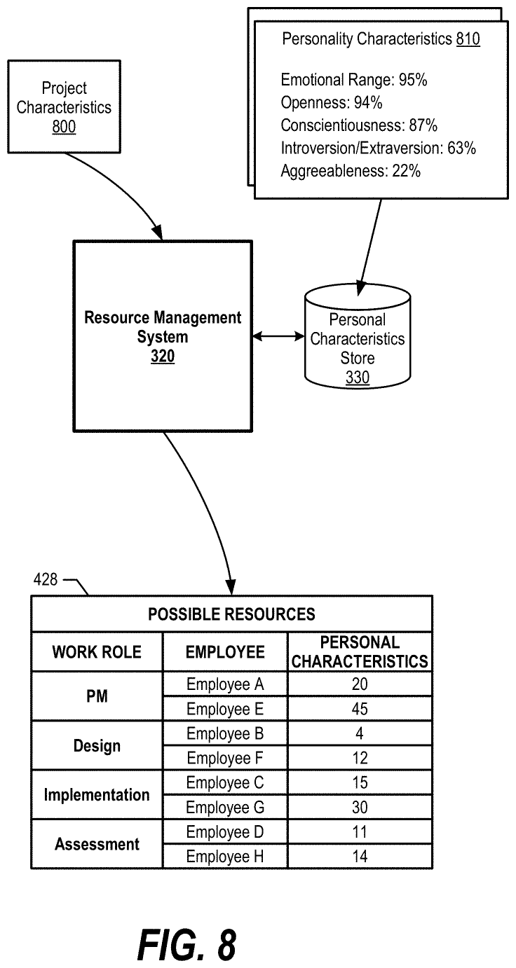

Resource selection system 300 includes project management system 310, which provides a user interface to project manager/resource 305, referred to herein as project manager 305. Resource management system 320 manages resource information, such as a resource's skill level and availability. In addition, resource management system 320 maintains personal characteristic data of the resources in personal characteristics store 330. The personal characteristics, in one embodiment, include personal attributes such as emotional range, openness, conscientiousness, introversion/extroversion, agreeableness, etc. (see FIG. 8 and corresponding text for further details).

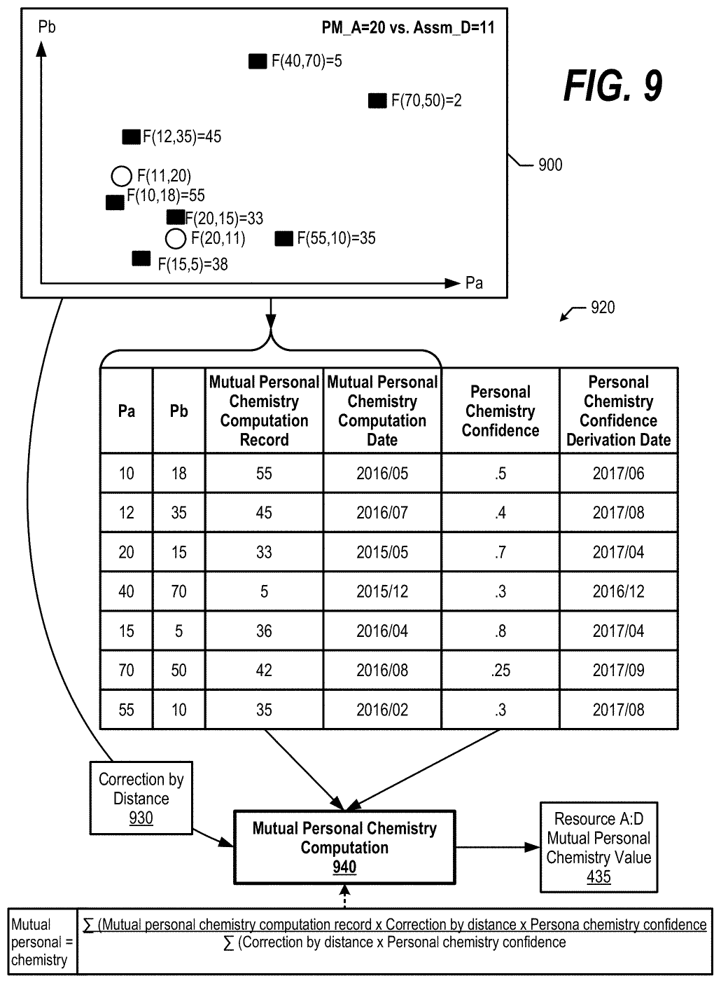

Cognitive computing system 340 determines a personal chemistry between two candidate resources, referred to herein as mutual personal chemistry, based on historical information and stores the information in personal chemistry store 350 (see FIG. 9 and corresponding text for further details).

Resource selection system 300 receives a set of project characteristics from project manager 305 and then identifies possible team candidates based on their qualifications, job title, and availability. For example, resource selection system 300 identifies three different project managers, two different design engineers, three different implementation specialists, etc.

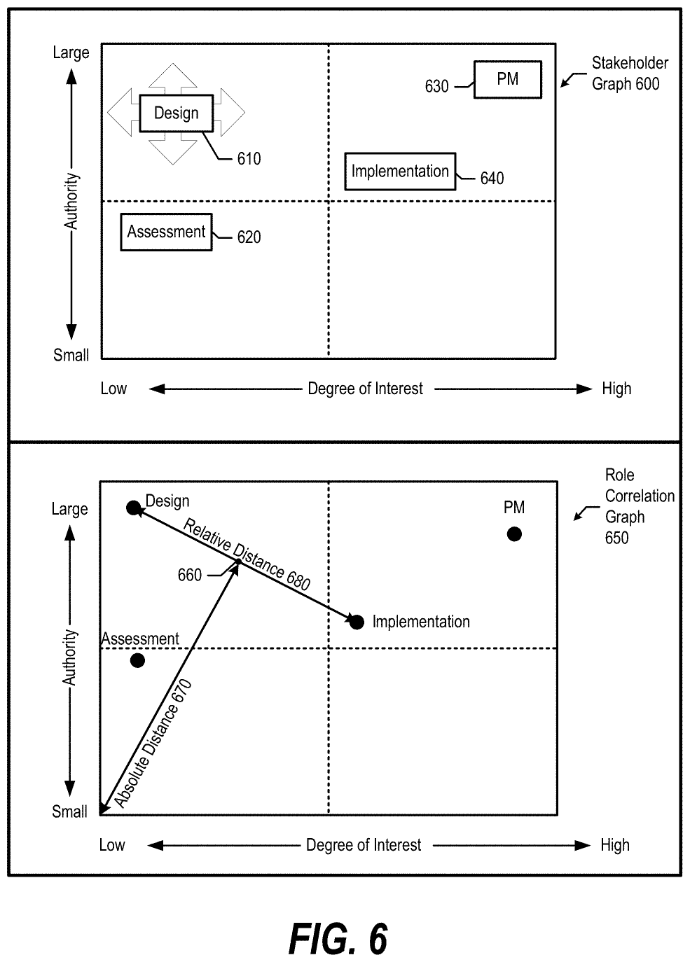

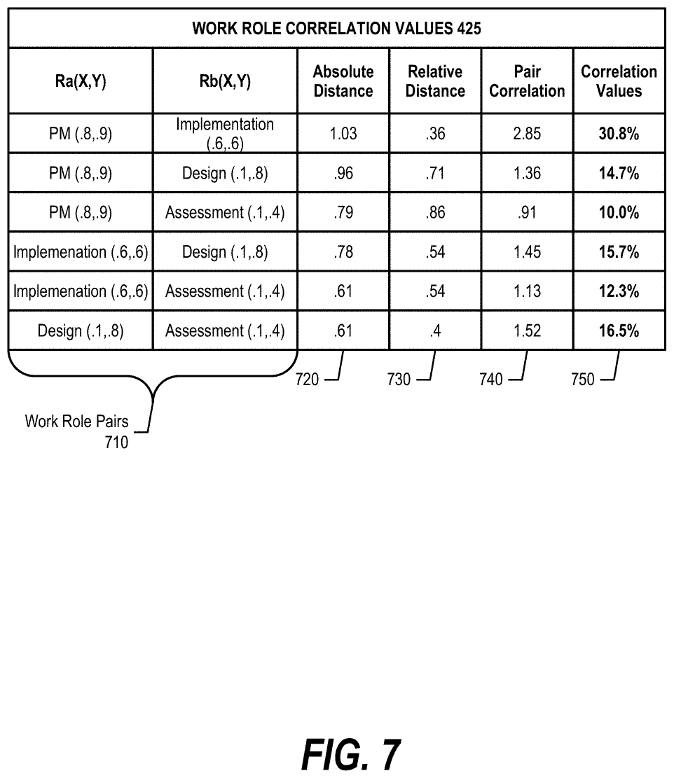

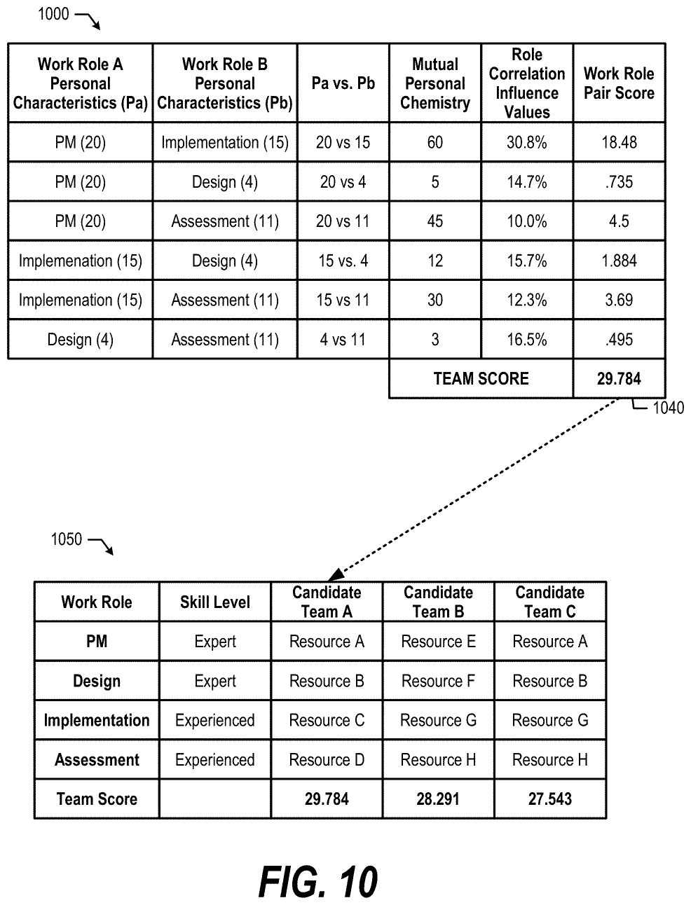

Next, resource selection system 300 computes work role correlations between the different work roles to determine the relationship between each work role in the project. The work role correlations are based on work role parameters such as degree of interest and degree of authority (see FIGS. 6, 7 and corresponding text for further details). Then, resource selection system 300 computes mutual personal chemistry values between the various team candidates and creates multiple candidate team scenarios. For example, team A includes Project Manager 1, Implementation 1, Design 1, team B includes Project Manager 1, Implementation 2, Design 3, and etcetera. Resource selection system 300 then determines team scores for each of the candidate teams based on the work role correlation values and the mutual personal chemistry scores. In turn, resource selection system 300 selects the candidate team with the highest team score (see FIG. 10 and corresponding text for further details).

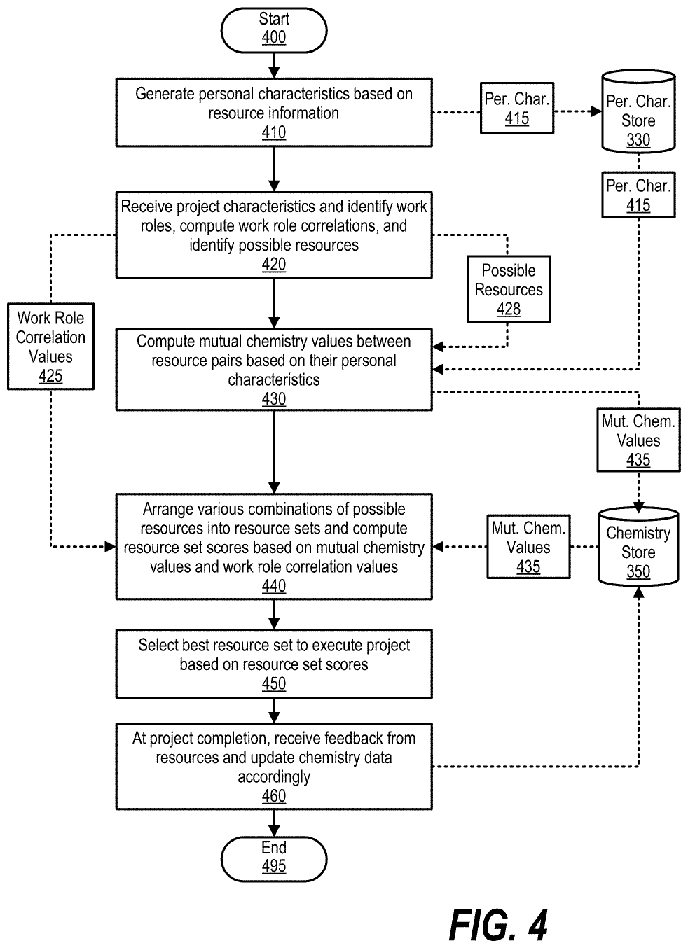

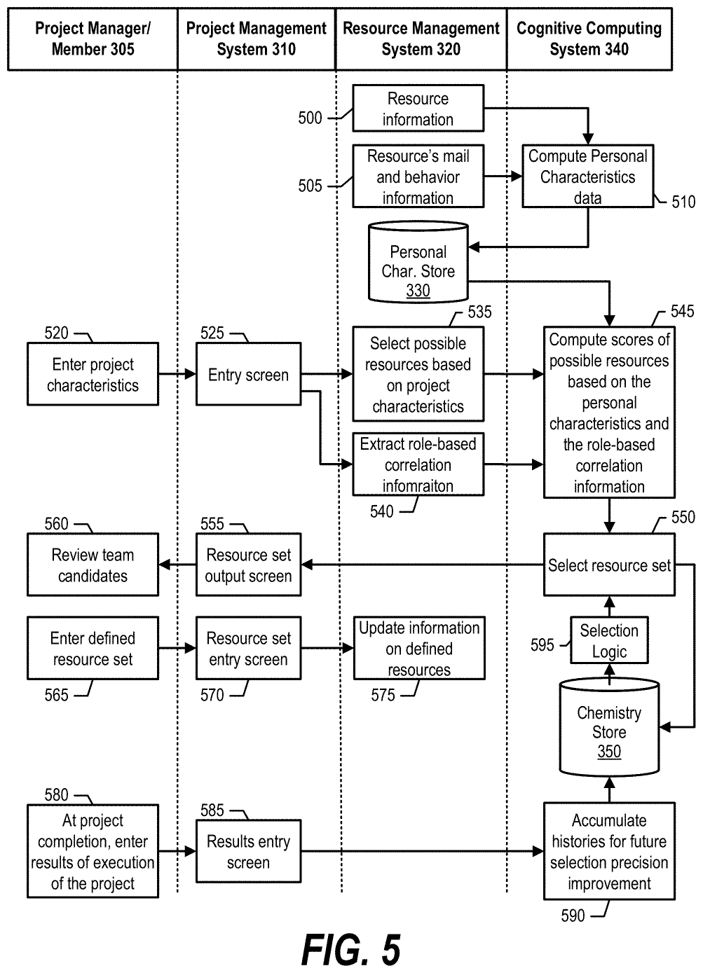

FIG. 4 is an exemplary flowchart showing steps taken by the resource selection system to select a team for a project. FIG. 4 processing commences at 400 whereupon, at step 410, the process generates personal characteristics 415 based on resource information (e.g. emails, documents, behavioral information, etc.) At step 420, the process receives project characteristics and identifies work roles, computes work role correlation values 425, and identifies possible resources 428 (see FIGS. 5-8 and corresponding text for further details).

At step 430, the process computes mutual chemistry values 435 between resource pairs based on their personal characteristics 415 (see FIG. 9 and corresponding text for further details). At step 440, the process arranges various combinations of possible resources into resource sets (e.g., teams) and computes resource set scores based on mutual chemistry values 435 and work role correlation values 425. At step 450, the process selects the best resource set to execute a project based on the resource set scores (see FIG. 10 and corresponding text for further details).

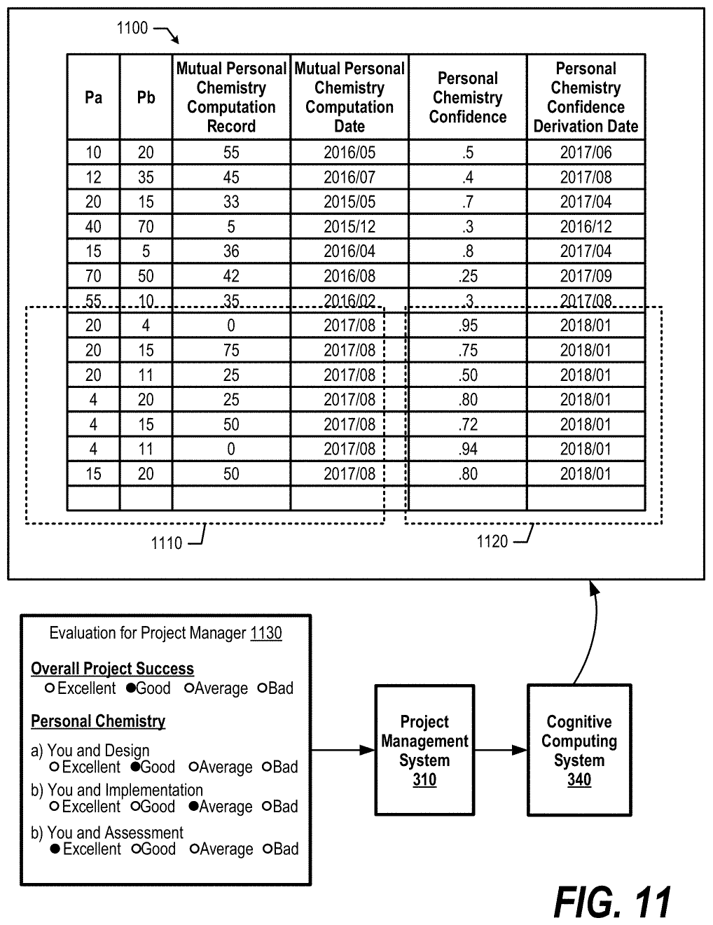

At step 460, at project completion, receives feedback from the resources on the project and updates chemistry data accordingly (see FIG. 11 and corresponding text for further details). FIG. 4 processing thereafter ends at 495.

FIG. 5 is an exemplary diagram depicting steps taken by various system components in resource selection system 300 to select a team based on their team chemistry score. Cognitive computing system 340 acquires resource information 500 and resource behavior information 505 periodically from resource management system 320 and computes personal characteristic data of the resources (team members) of the organization (510). Resource management system 320 stores the personal characteristic computation result in personal characteristics store 330.

At the beginning of a project, project manager 305 inputs project characteristics (520, e.g., organization chart, role, schedule) into project management system 310's entry screen (525). Resource management system 320 selects the resources who can participate on the basis of the project characteristics (535, e.g., organization chart, role, schedule, project type) and sends the information to cognitive computing system 340. In addition resource management system 320 extracts role-based correlation information (e.g., on a per-role basis) (540) and sends the role-based correlation information to cognitive computing system 340. In one embodiment, resource management system 320 extracts the correlation between the resources on the basis of the project characteristic (organization chart, role, project type).

Cognitive computing system 340 computes the scores of the resources based on the personal characteristics and the role-based correlation information (545). Cognitive computing system 340 then selects a resource set with multiple resources (550) having a resource set score from the result of 545 and sends information indicative of the resource organizations and scores of the resources to project management system 310 (555), which is displayed on project management system 310's screen.

Project manager 305 reviews the resource set information (560) and selects a resource set from the resource sets and defines the resources of the project (565) on the entry screen (570). In turn, resource management system 320 updates the information on the resources that have been defined (575).

When the project completes, project manager 305 enters the degree of success of the project (580) on a results screen (585) (see FIG. 11 and corresponding text for further details). In one embodiment, both project manager 305 and project resources enter the personal chemistry between resources in the project.

Cognitive computing system 340 accumulates the degree of success inputs into personal chemistry store 350 to improve the precision of future resource selections (590). In one embodiment, at the time of entering the execution results of the project, cognitive computing system 340 also improves selection logic 595 (see FIG. 11 and corresponding text for further details). As a result, the precision of selection logic 595 increases for future resource selections.

FIG. 6 is an exemplary diagram depicting a stakeholder entry graph and a correlation graph. Project manager 305 uses stakeholder graph 600 to enter various job requirement icons of work role attribute information corresponding to work roles of a project. Stakeholder graph 600 includes a project manager role 630, an implementation role 640, an assessment role 620, and a design role 610. For each of the work roles, a user drags and drops the role icons up/down/left/right to adjust work role attributes and have more/less authority correlation and/or more/less degree of interest correlation relative to the other roles. FIG. 6 shows that the project manager role 630 has the most authority in the team and interest with the success of a project. FIG. 6 also shows that an assessment role 620 has less interest and less authority for the project. In one embodiment, if the design role 610 has unique skills that are critical to the success of the project, the authority of the design role increases.

Once project manager 305 is finished adjusting the role icons in stakeholder graph 600, resource management system 320 computes role-based correlativity as discussed below using correlation graph 650, which includes role points corresponding to the role icons shown in stakeholder graph 600.

Resource management system 320 computes work role correlations between each work role position. Referencing role correlation graph 650, resource management system 320 computes the work role correlation between design point and implementation point using, in one embodiment, absolute distance 670 divided by relative distance 680. Point 660 is the midpoint of relative distance 680. Resource management system 320 computes influence levels of respective roles based on the aggregation of all pieces of the correlativity of each role into work role correlation values table 425 (see FIG. 7 and corresponding text for further details).

In one embodiment, additional role attributes such as “influence level” and “engagement level,” are adopted as correlational elements in correlation graph 650, which expands the amount of axes based on the amount of attributes. In this embodiment, the attributes and the number of axes may be selected as appropriate depending on the organization or project characteristics.

FIG. 7 is an exemplary diagram depicting work role correlation values between two work roles. Work role correlation values table 425 includes rows with various work role pairs (columns 710). Column 730 includes the absolute distance between the two role points (670) and column 740 includes the relative distance between the two role points (680). Column 750 includes a correlation value between the two role points, which is computed by dividing the absolute distance by the relative distance. And, column 760 includes the influence levels of the two roles based on their correlation divided by the aggregation of all correlations. As can be seen, the total correlation is 2.85+1.36+0.91+1.45+1.13+1.52=9.52 and the Project Manager/Implementation influence level is 2.85/9.52=30.8%. These influence levels are subsequently used to compute work role pair scores for a pair of candidate resources (see FIG. 10 and corresponding text for further details).

FIG. 8 is an exemplary diagram depicting a resource management system identifying possible candidates for a project based on project characteristics. Referring to 520-540 in FIG. 5, project manager 305 inputs project characteristics 800 into resource management system 320. Personality characteristics 810 that are based on, for example, analyzing user actions and writings, are stored in personal characteristics store 330.

Resource management system 320 selects candidate resources based on project characteristics (e.g., project time, time constraints, skills required) and extracts their personal characteristics from personal characteristics store 330.

Resource management system 320 then generates possible resources list 428 that includes candidate resources for each role and their corresponding personal characteristics. As discussed below, cognitive computing system 340 uses possible resources list 428 to compute mutual personal chemistry values for various resource combinations.

FIG. 9 is an exemplary diagram depicting cognitive computing system 340 using historical information to compute a mutual personal chemistry of candidate resources. In other words, cognitive computing system 340 determines that individual A with a personal characteristics A and individual B with personal characteristics B will have a mutual personal chemistry similar to two individuals on a past project with similar personal characteristics. Cognitive computing system 340 uses proximate points on graph 900 to compute the mutual personal chemistry values.

FIG. 9 shows that when the mutual personal chemistry between two resources whose personal chemistry data is given as (20, 11) is to be obtained, the point indicative of the necessary pieces of the personal chemistry data (20, 11) is plotted (along with the counter point (11,20)) on the matrix, and about 10 points close to the plotted points are selected from among the pieces of the past data in the neighborhood.

Cognitive computing system 340 uses, in one embodiment, mutual personal chemistry computation 940 to determine a mutual personal chemistry value 950 for each resource combination based on mutual personal chemistry computations, distances from target (correction by distance 930), etc . . . .

In one embodiment, correction by distance 930 in mutual personal chemistry computation 940 takes a value from 0 to 1. If the distance between the target point and the reference point is short, the value will be close to 1 while a value close to 0 will be given if the distance is long. For example, if the distance takes a value in the order of the range from 0 to 100, then the expression “Correction by distance =constant/(distance +constant)” is suited to select a value in the order of constant=10 to 20 and thus the correction that satisfies the above condition can be performed. In one embodiment, the objective of using const (constant) is to calculate the value from 0 to 1 and the calculated value is close to 1 if the distance is short and is close to 0 if the distance is long. For example, if const=10 and the distance is 3, the calculated value is 10/(10+3)=0.77 and if the distance is 20, the calculated value is 10/(10+20)=0.33.

In one embodiment, the personal chemistry confidence takes a value from 0 to 1 wherein a value close to 1 is entered as the personal chemistry confidence of the history information for a portion where both pieces of data share the same tendency, and a value close to 0 is entered as the personal chemistry confidence of the history information for a portion where tendencies away from each other can be observed for both pieces of data. For example, assuming that cognitive computing system 340 computes a mutual personal chemistry value of 35 between the Project Manager and Design work role, at the completion of the project, the personal chemistry self-assessed by the Project Manager to Design in step 580 (project execution result entry) is “Bad” (25), the calculated value of 35 and self-assessment value of 25 is close, therefore, the Personal Chemistry Confidence is assigned a value close to 1, such as 0.8. In another example, if the personal chemistry self-assessed by the Project Manager to Design is “Excellent” (100), the calculated value of 35 and self-assessment value of 100 are deviated from each other and, therefore, the Personal Chemistry Confidence is assigned a value close to 0, such as 0.13.

Cognitive computing system 340 replaces the candidate resources A and B by each other to recompute the mutual personal chemistry (20,11 to 11,20), and the average of the two values of the chemistry is adopted as the definitive mutual personal chemistry value 950 for the two resources A and B.

Once cognitive computing system 340 computes the mutual personal chemistry values for each candidate resource combination, cognitive computing system 340 computes a candidate team score for various candidate resource combinations (see FIG. 10 and corresponding text for further details).

FIG. 10 is an exemplary diagram depicting computations of a resource set (team) chemistry score for one set of resources inserted into a team selection table that includes multiple candidate resource set scores. The personal chemistry score of the resource set is computed based on the influence level that has been calculated in the step 540 (role-based correlation information extraction) and the mutual personal chemistry score that has been computed in the step 545 (calculation of the mutual personal chemistry score from the personal characteristics of the two resources), to extract the resources of the resource set constituting the group of personal chemistry having high probability of success as a resource set. Table 1000 shows a resource set score of one possible candidate resource set Project Manager 20, Implementation 15, Assessment 11, and Design 4.

The personal characteristics for the group of resources that have been extracted in the step 535 (project resource candidates selection) are extracted from resource management system 320. Pairs of two resources are taken from the group of the resources to compute the mutual personal chemistry values in step 545 (calculating mutual personal chemistry based on the personal characteristics of the two resources). The mutual personal chemistry that has been computed is multiplied by the influence level that has been previously computed and shown in FIG. 7 to compute a work role pair score for each candidate work role pair. Cognitive computing system 340 computes a work role pair score for each candidate work role pair and generates a resource set chemistry score 1040 based on the work role pair scores.

Resource set score 1040 is entered into table 1050, which compares resource set scores of various candidate resource sets. As can be seen, resource set A has the highest resource set score and, therefore, has the highest probability of successful team chemistry.

FIG. 11 is an exemplary diagram depicting a history log of information after completing a project. Table 1100 shows the addition of information 1110 and 1120. Information 1110 is added to the historical data during step 550 when cognitive computing system 340 selects resource set candidates. When a project completes, resources enter their evaluations of their personal chemistry between other resources. FIG. 11 shows evaluation 1130, which was inputted by the project manager via a user interface. Project management system 310 receives evaluation 1130 and passes evaluation 1130 to cognitive computing system 340. Cognitive computing system 340 analyzes evaluation 1130 and adds information 1120 to the historical data after the project completes (step 590).

Selection logic 595 is improved for further computation from the history information indicative of the history at the time when cognitive computing system 340 performed the computation in step 545 at the time of the beginning of the project, and the personal chemistry self-assessed by the project manager or a resource in step 580 (project execution result entry) and the performance information of the project success/failure at the time of the end of the project.

In one embodiment, the result obtained by setting the data computed in step 545 (project resource candidates selection) from the history information, and the personal chemistry performance self-assessed by the resource in step 580 at the time of the end of the project are sent to cognitive computing system 340.

In another embodiment, cognitive computing system 340 compares assessments computed by cognitive computing system 340 against self-assessments, and a value close to 1 is entered as the personal chemistry confidence of the history information for the portion where both pieces of data share the same tendency. In this embodiment, a value close to 0 is entered as the personal chemistry confidence of the history information for the portion where tendencies away from each other can be observed for both pieces of data.

When cognitive computing system 340 enters the personal chemistry confidence, correction is performed as appropriate such that, a value close to 1 is entered if the team chemistry score obtained from the history information and the tendency of the degree of success of the project self-assessed by the project manager in step 580 (project execution result entry) are similar to each other, and a value close to 0 is entered if they are deviated from each other. In turn, the results are added as history information to information 1100.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
computing a plurality of work role correlation values corresponding to a plurality of work role pairs, wherein each of the plurality of work role pairs comprises a pair of a plurality of work roles corresponding to a project;
grouping a plurality of resources into a plurality of resource sets, wherein each of the plurality of resources correspond to one of the plurality of work roles, and wherein each of the plurality of resource sets comprises a unique set of the plurality of resources;
computing a plurality of resource set scores for the plurality of resource sets based on their respective unique set of resources and the plurality of work role correlation values; and
selecting one of the plurality of resource sets based on the plurality of resource set scores.

2. The method of claim 1 further comprising:
selecting one of the plurality of work role pairs that comprises a first work role and a second work role;
positioning a first icon corresponding to the first work role on a stakeholders map at a first position based on a set of first role attributes corresponding to the first work role;
positioning a second icon corresponding to the second work role on the stakeholders map at a second position based on a set of second role attributes corresponding to the second work role; and
computing one of the plurality of work role correlation values based on the first position of the first icon and the second position of the second icon.

3. The method of claim 2 further comprising:
in response to receiving a user action to move the second icon to a third position, repositioning the second icon to the third position on the stakeholders map; and
computing one of the plurality of work role correlation values based on the first position of the first icon and the third position of the second icon.

4. The method of claim 1 further comprising:
selecting one of the plurality of resource sets that comprises a first resource and a second resource;
retrieving a set of first characteristics corresponding to the first resource and a set of second characteristics corresponding to the second resource;
computing a mutual chemistry value between the first resource and the second resource based on the set of first characteristics and the set of second characteristics; and
utilizing the mutual chemistry value in the computing of at least one of the plurality of resource set scores.

5. The method of claim 4 further comprising:
matching the mutual chemistry value to a selected one of the plurality of work role correlation values based on the corresponding work role of the first resource and the second resource;
computing a work role pair score of the first resource and the second resource based on the matched mutual chemistry value and the selected work role correlation value; and
applying the work role pair score to the at least one of the plurality of resource set scores.

6. The method of claim 4 wherein the set of first characteristics indicates a first personality of the first resource and the set of second characteristics indicates a second personality of the second resource.

7. The method of claim 1 further comprising:
in response to the selected resource set completing the project, receiving performance data from the set of resources included in the selected resource set; and
utilizing the performance data in a future computation of a plurality of future resource set scores.

8. An information handling system comprising:
one or more processors;
a memory coupled to at least one of the processors;
a set of computer program instructions stored in the memory and executed by at least one of the processors in order to perform actions of:
computing a plurality of work role correlation values corresponding to a plurality of work role pairs, wherein each of the plurality of work role pairs comprises a pair of a plurality of work roles corresponding to a project;
grouping a plurality of resources into a plurality of resource sets, wherein each of the plurality of resources correspond to one of the plurality of work roles, and wherein each of the plurality of resource sets comprises a unique set of the plurality of resources;
computing a plurality of resource set scores for the plurality of resource sets based on their respective unique set of resources and the plurality of work role correlation values; and
selecting one of the plurality of resource sets based on the plurality of resource set scores.

9. The information handling system of claim 8 wherein the processors perform additional actions comprising:
selecting one of the plurality of work role pairs that comprises a first work role and a second work role;
positioning a first icon corresponding to the first work role on a stakeholders map at a first position based on a set of first role attributes corresponding to the first work role;
positioning a second icon corresponding to the second work role on the stakeholders map at a second position based on a set of second role attributes corresponding to the second work role; and
computing one of the plurality of work role correlation values based on the first position of the first icon and the second position of the second icon.

10. The information handling system of claim 9 wherein the processors perform additional actions comprising:
in response to receiving a user action to move the second icon to a third position, repositioning the second icon to the third position on the stakeholders map; and
computing one of the plurality of work role correlation values based on the first position of the first icon and the third position of the second icon.

11. The information handling system of claim 8 wherein the processors perform additional actions comprising:
selecting one of the plurality of resource sets that comprises a first resource and a second resource;
retrieving a set of first characteristics corresponding to the first resource and a set of second characteristics corresponding to the second resource;
computing a mutual chemistry value between the first resource and the second resource based on the set of first characteristics and the set of second characteristics; and
utilizing the mutual chemistry value in the computing of at least one of the plurality of resource set scores.

12. The information handling system of claim 11 wherein the processors perform additional actions comprising:
matching the mutual chemistry value to a selected one of the plurality of work role correlation values based on the corresponding work role of the first resource and the second resource;
computing a work role pair score of the first resource and the second resource based on the matched mutual chemistry value and the selected work role correlation value; and
applying the work role pair score to the at least one of the plurality of resource set scores.

13. The information handling system of claim 11 wherein the set of first characteristics indicates a first personality of the first resource and the set of second characteristics indicates a second personality of the second resource.

14. The information handling system of claim 8 wherein the processors perform additional actions comprising:
in response to the selected resource set completing the project, receiving performance data from the set of resources included in the selected resource set; and
utilizing the performance data in a future computation of a plurality of future resource set scores.

15. A computer program product stored in a computer readable storage medium, comprising computer program code that, when executed by an information handling system, causes the information handling system to perform actions comprising:
computing a plurality of work role correlation values corresponding to a plurality of work role pairs, wherein each of the plurality of work role pairs comprises a pair of a plurality of work roles corresponding to a project;
grouping a plurality of resources into a plurality of resource sets, wherein each of the plurality of resources correspond to one of the plurality of work roles, and wherein each of the plurality of resource sets comprises a unique set of the plurality of resources;
computing a plurality of resource set scores for the plurality of resource sets based on their respective unique set of resources and the plurality of work role correlation values; and
selecting one of the plurality of resource sets based on the plurality of resource set scores.

16. The computer program product of claim 15 wherein the information handling system performs further actions comprising:
selecting one of the plurality of work role pairs that comprises a first work role and a second work role;
positioning a first icon corresponding to the first work role on a stakeholders map at a first position based on a set of first role attributes corresponding to the first work role;
positioning a second icon corresponding to the second work role on the stakeholders map at a second position based on a set of second role attributes corresponding to the second work role; and
computing one of the plurality of work role correlation values based on the first position of the first icon and the second position of the second icon.

17. The computer program product of claim 16 wherein the information handling system performs further actions comprising:
in response to receiving a user action to move the second icon to a third position, repositioning the second icon to the third position on the stakeholders map; and
computing one of the plurality of work role correlation values based on the first position of the first icon and the third position of the second icon.

18. The computer program product of claim 15 wherein the information handling system performs further actions comprising:
selecting one of the plurality of resource sets that comprises a first resource and a second resource;
retrieving a set of first characteristics corresponding to the first resource and a set of second characteristics corresponding to the second resource;
computing a mutual chemistry value between the first resource and the second resource based on the set of first characteristics and the set of second characteristics; and
utilizing the mutual chemistry value in the computing of at least one of the plurality of resource set scores.

19. The computer program product of claim 18 wherein the information handling system performs further actions comprising:
matching the mutual chemistry value to a selected one of the plurality of work role correlation values based on the corresponding work role of the first resource and the second resource;
computing a work role pair score of the first resource and the second resource based on the matched mutual chemistry value and the selected work role correlation value; and
applying the work role pair score to the at least one of the plurality of resource set scores.

20. The computer program product of claim 15 wherein the information handling system performs further actions comprising:
in response to the selected resource set completing the project, receiving performance data from the set of resources included in the selected resource set; and
utilizing the performance data in a future computation of a plurality of future resource set scores.
